(19) United States
(12) Patent Application Publication
(10) Pub. No.: US 2026/0063482 A1
(43) Pub. Date: Mar. 5, 2026

(54) STRAIN GAUGE, STRAIN MEASUREMENT DEVICE, AND STRAIN MEASUREMENT METHOD

(71) Applicant: RESEARCH INSTITUTE FOR ELECTROMAGNETIC MATERIALS, TOMIYA-SHI (JP)

(72) Inventors: Nobukiyo KOBAYASHI, TOMIYA-SHI (JP); Yui HASEGAWA, TOMIYA-SHI (JP); Kenji IKEDA, TOMIYA-SHI (JP); Tadayoshi IWASA, TOMIYA-SHI (JP)

(21) Appl. No.: 19/310,224

(22) Filed: Aug. 26, 2025

(30) Foreign Application Priority Data
Sep. 3, 2024 (JP) 2024-151822
Feb. 14, 2025 (JP) 2025-022672

(51) Int. Cl. G01L 1/22

(52) U.S. Cl. CPC G01L 1/2287; G01L 1/2262

(57) ABSTRACT

To provide a strain gauge that can achieve improvement of practicality. A nano-granular structure film constituting a resistor 2 formed on one main surface of a substrate 1 of a strain gauge has a composition represented by a general formula L_{100-a-b-c}MₐF_{b}O_{c} (L is one or more metal elements selected from Fe, Co, Ni, Pt, Au, Ag, and Cu; M is one or more elements selected from Li, Mg, Al, Ca, Sr, Ba, Gd, and Y: F is fluorine: O is oxygen; and 40.0≤(a+b+c)≤63.0). The resistor 2 is constituted of a nano-granular structure film in which metal particles Q1 represented by L and having an average particle diameter of 1.0 to 5.0 nm are distributed in an insulating matrix Q2 formed of a fluoride of M or a fluoride and an oxide of M.

### BACKGROUND OF THE INVENTION

### Field of the Invention

The present invention relates to a technique of measuring strain of an object.

### Description of the Related Art

In response to deformation of a nano-granular structure film including nanometer-sized metal particles dispersed in a fluoride matrix, such a phenomenon that an interval between the metal particles changes to thereby change electrical conductivity of the nano-granular structure film has been reported (see, for example, S. Kaji, G. Oomi, S. Mitani, S. Takahashi, K. Takanashi, and S. Maekawa Phys. Rev. B68, 054429 (2003)).

### PRIOR ART DOCUMENT

### Non-Patent Literature

Non-Patent Literature 1: S. Kaji, G. Oomi, S. Mitani, S. Takahashi, K. Takanashi, and S. Maekawa Phys. Rev. B68, 054429 (2003)
Non-Patent Literature 2: S. Mitani, S. Takahashi, K. Takanashi, K. Yakushiji, S. Maekawa, and H. Fujimori Phys. Rev. Lett. 81, 2799 (1998)
Non-Patent Literature 3: Takashi Odagaki, Science of percolation, Shokabo (1993)

However, the above-described phenomenon occurs at an extremely low temperature near a liquid helium temperature, and therefore practical application of products or the like that uses the above-described phenomenon is difficult.

Therefore, an object of the present invention is to provide a strain gauge that can achieve improvement of practicality.

### SUMMARY OF THE INVENTION

A strain gauge of the present invention is a strain gauge including a substrate and a resistor formed on a surface of the substrate, wherein the resistor is constituted of a nano-granular structure film which has a composition represented by a general formula L_{100-a-b-c}MₐF_{b}O_{c} (L is one or more metal elements selected from Fe, Co, Ni, Pt, Au, Ag, and Cu; M is one or more elements selected from Li, Mg, Al, Ca, Sr, Ba, Gd, and Y; F is fluorine; O is oxygen; and 40≤(a+b+c)≤63), and in which metal particles represented by L and having an average particle diameter of 1.0 to 5.0 nm are distributed in an insulating matrix formed of a fluoride of M or a fluoride and an oxide of M.

### Advantageous Effects of Invention

According to the strain gauge of the present invention, when a nano-granular structure film constituting a resistor is deformed, an interval between metal particles constituting the nano-granular structure film changes. This changes the thickness of a tunnel barrier between the particles (granules) and changes electrical conductivity. As a result, electrical resistivity of the whole film is increased, and a high electrical resistivity, which is almost similar to that in the extremely low region as described in S. Kaji, G. Oomi, S. Mitani, S. Takahashi, K. Takanashi, and S. Maekawa Phys. Rev. B68, 054429 (2003), is exhibited even at room temperature. Moreover, even at room temperature, electrical conduction due to the high-order tunneling as described in S. Mitani, S. Takahashi, K. Takanashi, K. Yakushiji, S. Maekawa, and H. Fujimori Phys. Rev. Lett. 81, 2799 (1998) is achieved, resulting in improvement of the gauge rate of the strain gauge and therefore improvement of its practicality.

An effect of the present invention is that, since tunnel conduction based on a nano-granular structure is required, a degree of crystallinity of an insulating matrix of 20% or higher can ensure that the band gap of a substance constituting the insulating matrix that forms a tunnel barrier has a value having a sufficient insulating property (5 eV or more).

In the nano-granular structure, there exists a region where physical properties such as electrical conduction characteristics change discontinuously. The region is a percolation threshold defined by the percolation theory in Takashi Odagaki, Science of percolation, Shokabo (1993), and, in the nano-granular structure, granules in the nano-granular structure change from an isolated state to a continuous state due to contact or the like at the percolation threshold. This structural change causes electrical conduction to change from tunnel conduction to metal conduction. In the region near the percolation threshold, when particles do not contact and tunnel conduction is maintained, an extremely thin tunnel barrier is formed, and an increased tunnel establishment due to the thinner tunnel barrier increases occurrence of the tunnel conduction phenomenon including the high-order tunneling.

### BRIEF DESCRIPTION OF THE DRAWINGS

FIG. 1 shows a configuration explanation diagram of a strain gauge as one embodiment of the present invention;

FIG. 2 shows an explanation view of a microstructure of a resistor;

FIG. 3 shows an explanation view of a relationship between an atomic ratio a+b+c of a resistor of the present invention and a gauge rate of a strain gauge;

FIG. 4 shows an explanation view of a relationship between an atomic ratio a+b+c of a resistor of the present invention and temperature dependency of a gauge rate of a strain gauge;

FIG. 5A shows an explanation view with respect to temperature dependency of a gauge rate of one embodiment; and

FIG. 5B shows an explanation view with respect to temperature dependency of a gauge rate of another embodiment.

### DETAILED DESCRIPTION OF THE INVENTION

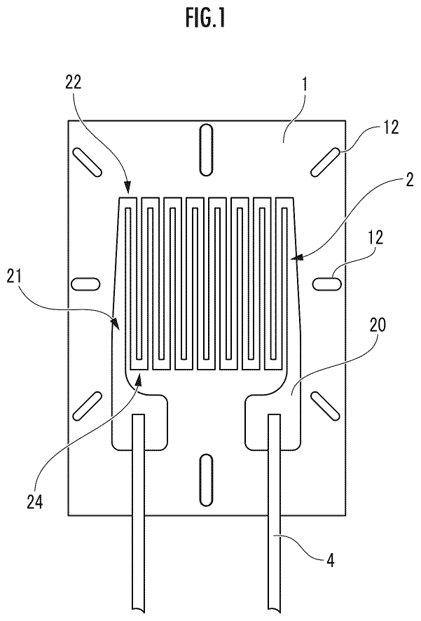

The strain gauge as an embodiment of the present invention shown in FIG. 1 includes a substrate 1 and a resistor 2.

The substrate 1 is composed of an insulating material having a flexibility such as glass, quartz glass, an Si wafer having an oxidized surface, an epoxy resin, or the like, and is formed into, for example, an almost rectangular plate. In addition, the substrate 1 is composed of a metal, and an insulating thin film including a polyimide, an oxide such as Al₂O₃, a fluoride such as MgF₂, an epoxy resin, or the like may be formed on at least one main surface thereof. One main surface of the substrate 1 is provided with a reference mark 12 (such as center mark) that serve as a reference of the position and orientation of the strain gauge (resistor 2).

The resistor 2 is formed on one main surface of the substrate 1, and is constituted of a nano-granular structure film or a nano-granular thin film having a predetermined gauge pattern. For example, as shown in FIG. 1, the resistor 2 includes a plurality of straight parts 21 that extend almost linearly in the longitudinal direction of the substrate 1 while the plurality of straight parts 21 are folded at a distal folded tab 22 and a proximal folded tab 24 from one gauge tab 20 to the other gauge tab 20. A pair of gauge leads 4 are each connected to a pair of gauge tabs 20. The gauge pattern of the resistor 2 may be variously modified.

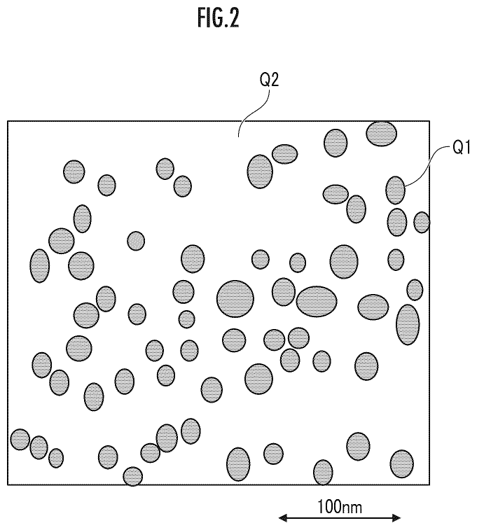

As schematically shown in FIG. 2, the resistor 2 is constituted of a nano-granular structure film, in which nanometer-sized metal particles Q1 are almost uniformly dispersed and positioned in an insulating matrix Q2. The thickness of the nano-granular structure film is, for example, 0.1 to 10.0 μm.

The nano-granular structure film has a composition represented by a general formula L_{100-a-b-c}MₐF_{b}O_{c} (L is one or more metal elements selected from Fe, Co, Ni, Pt, Au, Ag, and Cu; M is one or more elements selected from Li, Mg, Al, Ca, Sr, Ba, Gd, and Y; F is fluorine; O is oxygen; and 40.0≤(a+b+c)≤63.0). The average particle diameter of the metal particles Q1 is 1.0 to 5.0 nm. The metal particles Q1 are distributed in the insulating matrix Q2 formed of a fluoride of M or a fluoride and an oxide of M. The elements of L and M are selected from a combination that results in a nano-granular structure in which the metal particles Q1 are mainly composed of L and the insulating matrix is mainly composed of M, F, and O. a, b, and c are, for example, 12.0≤a≤22.0, 17.0≤b≤46.0, 0≤c≤1.0. In addition, the insulating matrix Q2 preferably has a degree of crystallinity of 20% or more.

The other main surface of the substrate 1 may be provided with an insulating protective layer or protective film (for example, SiO₂, Al₂O₃, or the like) to cover the resistor 2.

### (Manufacturing Method)

A film of the resistor 2 constituting the strain gauge is formed on one main surface of the substrate 1 by using the sputtering method or an RF sputtering film formation apparatus. A target of at least one or more nonmagnetic metal elements of Fe, Co, Ni, Pt, Au, Ag, and Cu and a target of a fluoride (or a fluoride and an oxide) of one or more elements selected from Li, Mg, Al, Ca, Sr, Ba, Gd, and Y are sputtered at the same time. The composition of the resistor 2 is adjusted by the ratio of the area, the number, or the like of a chip of Fe, Co, Ni, Pt, Au, Ag, or Cu positioned on the target facing the substrate 1. This makes it possible to obtain a nano-granular structure film, in which nanometer-sized metal particles are dispersed in a matrix formed of a fluoride.

An Ar gas or a mixed gas of Ar and O₂ (0.1 to 10%) is used for the sputtering film formation. The film thickness of the resistor 2 is controlled by increasing or decreasing the time of film formation, to form a film of the resistor 2 having a film thickness of about 0.3 to 5.0 [μm]. In order to control a degree of crystallinity of the resistor 2, the substrate is controlled to have an optional temperature of the temperature range of 200 to 600 [° C.], 250 to 550 [° C.], or 300 to 500 [° C.]. The sputtering pressure at the film formation is controlled to 1 to 60 [mTorr]. The sputtering electric power is adjusted within a range of 50 to 350 [W]. It is known that the degree of crystallinity of the resistor 2 changes depending on a composition of the resistor 2. Therefore, depending on the above-described composition, the substrate temperature, the pressure at the film formation, and the sputtering electric power may be controlled.

### EXAMPLE

A Co target (diameter 76 mm) and a powder sintered target of BaF₂ (diameter 76 mm) were sputtered using an RF sputtering apparatus at the same time to result in film formation of a nano-granular thin film on a substrate. As the substrate, 50×50 mm corning-XG glass with a thickness of 0.5 mm was used, and the substrate temperature during the film formation was adjusted to 300° C. by a ramp heating system. The thus-obtained nano-granular thin film was used to produce a strain gauge of Example 1. Similarly, according to the above-described embodiment, the temperature, pressure, electric power, and the like were each adjusted, and particularly the substrate temperature was controlled to a temperature included in a range of 200 to 500° C., resulting in film formation of a nano-granular thin film. Then, strain gauges of Examples 2 to 23 were each produced by using them.

### COMPARATIVE EXAMPLE

According to the same conditions as those of Examples, strain gauges of Comparative Examples 1 and 2 that include nano-granular thin films having a composition shown in Table 1 were produced.

Table 1 summarizes and shows compositions of nano-granular thin films constituting the respective strain gauges of Examples 1 to 23 and Comparative Examples 1 and 2, gauge rates of the strain gauges, degrees of crystallinity determined by results of X ray diffraction of the insulating matrix Q2, rates of change in temperature of the gauge rates at 0 to 50° C., and substrate temperatures during the film formation. Note that, since the substrate temperature during film formation is measured by the ramp heating system, an error of up to ±10% may occur. In XRD, profile fitting can be performed within a certain range around the main peak of a fluoride or a fluoride oxide constituting the insulating matrix Q2 to calculate the degree of crystallinity. However, since the nanogranular structure has a nanometer-sized microstructure, the presence of the contained microcrystalline phase can broaden the XRD peak, making it difficult to distinguish it from the amorphous phase. Therefore, even if the degree of crystallinity of the insulating matrix Q2 of a certain sample is measured to be 70% based on XRD, the degree of crystallinity of the insulating matrix Q2 of a sample produced under the same manufacturing conditions may be measured to be 80% to 90%, or 85% to 95%.

TABLE 1

| | | | | | Gauge rate | |
|---|---|---|---|---|---|---|
| | | | | | rate of | |
| | | | | Degree of | change in | Substrate |
| | | a + | Gauge | crystallinity | temperature | temperature |
| | Composition [at. %] | b + c | rate | % | ppm/° C. | ° C. |
| Example 1 | Co_{45.7}Ba_{18.4}F_{35.9} | 54.3 | 12.9 | 45 | 420 | 300 |
| Example 2 | Co_{42.4}Fe_{7.5}Ba_{14.4}F_{35.7} | 50.1 | 14.0 | 38 | 120 | 200 |
| Example 3 | Co_{31.6}Ni_{6.3}Ca_{17.4}F_{44.7} | 62.1 | 13.9 | 43 | 1490 | 500 |
| Example 4 | Co_{45.9}Fe_{0.8}Mg_{15.0}F_{38.2}O_{0.1} | 53.3 | 26.9 | 55 | 323 | 500 |
| Example 5 | Pt_{46.1}Ba_{15.1}F_{38.8} | 53.9 | 17.9 | 61 | 388 | 500 |
| Example 6 | Pt_{41.4}Au_{0.5}Ba_{15.9}F_{42.2} | 58.1 | 13.6 | 47 | 480 | 500 |
| Example 7 | Pt_{41.4}Au_{0.3}Mg_{16.1}F_{42.1}O_{0.1} | 58.6 | 13.5 | 35 | 1092 | 400 |
| Example 8 | Cu_{44.2}Ba_{15.6}F_{40.2} | 55.8 | 14.4 | 43 | 602 | 500 |
| Example 9 | Cu_{45.5}Mg_{14.5}F_{40.0} | 54.5 | 15.2 | 48 | 516 | 500 |
| Example 10 | Cu_{43.5}Ca_{15.6}F_{40.8}O_{0.1} | 56.5 | 16.2 | 41 | 943 | 500 |
| Example 11 | Ni_{42.1}Ba_{12.8}F_{45.1} | 57.9 | 11.6 | 24 | 1215 | 200 |
| Example 12 | Ni_{40.9}Fe_{0.7}Ba_{17.8}F_{40.6} | 58.4 | 13.2 | 40 | 1105 | 500 |
| Example 13 | Ni_{45.4}Fe_{0.6}Ba_{15.3}F_{38.6}O_{0.1} | 54.0 | 16.1 | 52 | 431 | 500 |
| Example 14 | Co_{38.6}Fe_{0.3}Ba_{13.8}Li_{8.2}F_{39.1} | 61.1 | 13.8 | 34 | 1496 | 500 |
| Example 15 | Co_{41.9}Fe_{0.3}Ba_{10.0}Al_{5.9}F_{41.9} | 57.8 | 13.6 | 43 | 1220 | 500 |
| Example 16 | Co_{40.6}Fe_{0.3}Ba_{10.2}Sr_{6.9}F_{42.0} | 59.1 | 15.2 | 38 | 923 | 400 |
| Example 17 | Co_{43.4}Fe_{0.6}Ba_{8.2}Gd_{7.7}F_{40.1} | 56.0 | 11.1 | 52 | 630 | 300 |
| Example 18 | Au_{41.9}Ag_{0.3}Ba_{12.5}Li_{3.5}F_{41.8} | 57.8 | 13.4 | 46 | 753 | 450 |
| Example 19 | Au_{40.2}Ag_{0.2}Ba_{12.2}Gd_{4.1}F_{43.3} | 59.6 | 12.2 | 39 | 1395 | 400 |
| Example 20 | Co_{45.8}Fe_{0.4}Ba_{8.6}Sr_{3.2}Y_{3.1}F_{38.9} | 53.8 | 19.8 | 64 | 562 | 500 |
| Example 21 | Co_{36.8}Fe_{0.3}Al_{18.1}F_{44.8} | 62.9 | 11.8 | 19 | 2546 | 200 |
| Example 22 | Co_{49.4}Fe_{0.5}Ba_{14.4}F_{35.7} | 50.1 | 26.9 | 55 | 220 | 500 |
| Example 23 | Co_{59.5}Fe_{0.5}Ba_{13.9}F_{26.1} | 40.0 | 6.6 | 19 | 250 | 200 |
| Comparative | Co_{64.8}Ba_{10.6}F_{24.6} | 35.2 | 2 | 67 | — | 500 |
| Example 1 | | | | | | |
| Comparative | Co_{69.2}Mg_{9.8}F_{21.0} | 30.8 | 1.5 | 72 | — | 500 |
| Example 2 | | | | | | |

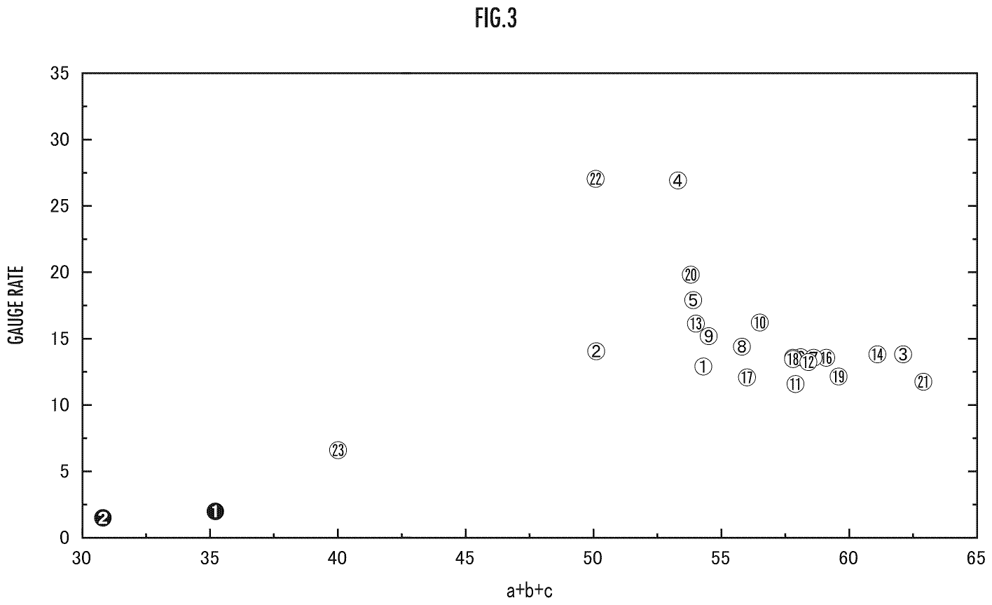

In FIG. 3, correlations between a+b+c that represents compositions of nano-granular thin films constituting strain gauges of Examples 1 to 23 and the gauge rates at room temperature are shown by plots of numbers corresponding to the numbers of the respective Examples enclosed within circles. In FIG. 3, the above-descried correlations of the strain gauges of Comparative Example 1 and Comparative Example 2 are represented by plots of filled circles corresponding to the numbers of the respective Comparative Examples. It is found from Table 1 and FIG. 3 that the gauge rates of the strain gauges of Examples 4, 5, 9, 10, 13, 16, 20, and 22 are 15 or more, which are higher than the gauge rates of the strain gauges of the other Examples. The degrees of crystallinity of the nano-granular thin films constituting the strain gauges of Examples 4, 5, 9, 10, 13, 16, 20, and 22 are included within the range of 38% to 64%, and a+b+c is included within the range of 50.1% to 59.1%. The degrees of crystallinity of the nano-granular thin films constituting the strain gauges of Examples 4, 13, 16, 20, and 22, in which L is one or more magnetic metal elements selected from Fe, Co, and Ni, are included within the range of 38% to 64%, and a+b+c is included within the range of 50.1% to 59.1%. The degrees of crystallinity of the nano-granular thin films constituting the strain gauges of Examples 5, 9, and 10, in which L is one or more nonmagnetic metal elements selected from Pt, Au, Ag, and Cu, are included within the range of 41% to 61%, and a+b+c is included within the range of 53.9 to 56.5%.

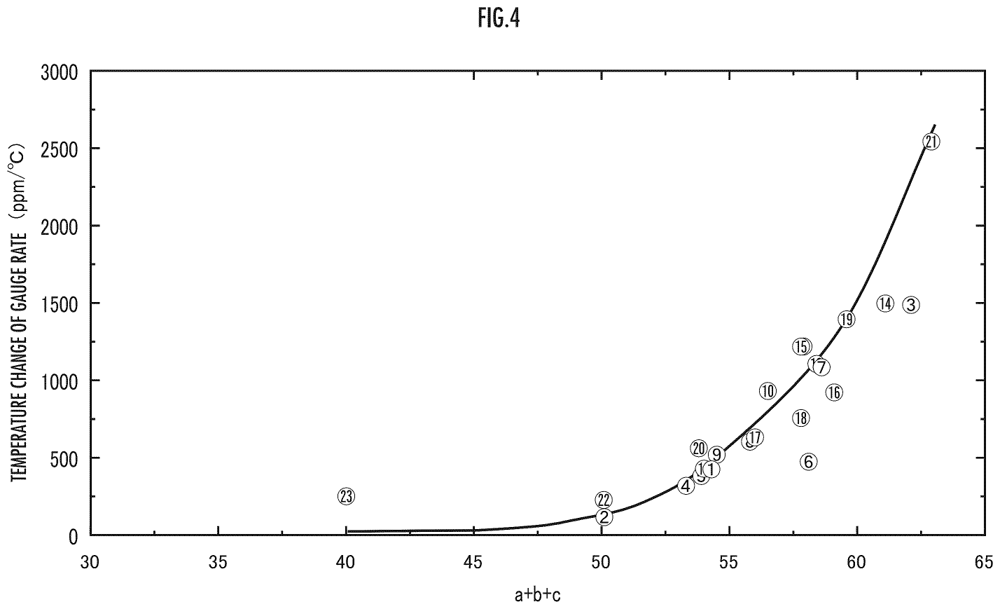

In FIG. 4, correlations between a+b+c that represents compositions of nano-granular thin films constituting strain gauges of Examples 1 to 23 and rates of change in temperature of the gauge rates at 0° C. to 50° C. are shown by plots of numbers corresponding to the numbers of the respective Examples enclosed within circles. It is found from Table 1 and FIG. 4 that the rates of change in temperature of the gauge rates of the strain gauges of Examples 1, 2, 4, 5, 6, 8, 9, 10, 13, 16, 17, 18, 20, 22, and 23 are smaller than 1000 ppm/° C., which are lower than those of the strain gauges of the other Examples. The degrees of crystallinity of the nano-granular thin films constituting the strain gauges of Examples 1, 2, 4, 5, 6, 8, 9, 10, 13, 16, 17, 18, 20, and 22 are included within the range of 38% to 64%, and a+b+c is included within the range of 50.1% to 59.1%. The degrees of crystallinity of the nano-granular thin films constituting the strain gauges of Examples 1, 2, 4, 13, 16, 17, 20, and 22, in which L is one or more magnetic metal elements selected from Fe, Co, and Ni, are included within the range of 38% to 64%, and a+b+c is included within the range of 50.1% to 59.1%. The degrees of crystallinity of the nano-granular thin films constituting the strain gauges of Examples 5, 6, 8, 9, 10, and 18, in which L is one or more nonmagnetic metal elements selected from Pt, Au, Ag, and Cu, are included within the range of 41% to 61%, and a+b+c is included within the range of 54.5% to 58.1%.

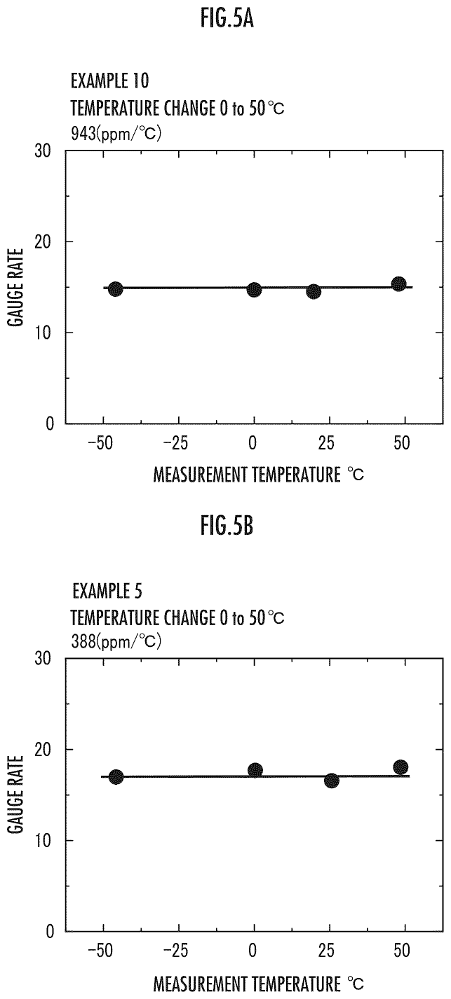

FIG. 5A and FIG. 5B show temperature dependency of the gauge rates of the strain gauges of Example 10 and Example 5 when each of the strain gauges is placed in a temperature environment of −50° C. to 50° C.

### REFERENCE SIGNS LIST

1 substrate
12 reference mark
2 resistor
20 gauge tab
21 straight part
22 distal folded tab
24 proximal folded tab
4 gauge lead
Q1 metal particles
Q2 insulating matrix.

1. A strain gauge comprising:
a substrate; and
a resistor formed on a surface of the substrate,
wherein the resistor is constituted of a nano-granular structure film which has a composition represented by a general formula L_{100-a-b-c}MₐF_{b}O_{c}, wherein L is one or more metal elements selected from Fe, Co, Ni, Pt, Au, Ag, and Cu; M is one or more elements selected from Li, Mg, Al, Ca, Sr, Ba, Gd, and Y; F is fluorine; O is oxygen; and 40.0≤(a+b+c)≤63.0, and in which metal particles represented by L and having an average particle diameter of 1.0 to 5.0 nm are distributed in an insulating matrix formed of a fluoride of M or a fluoride and an oxide of M.

2. The strain gauge according to claim 1,
wherein a degree of crystallinity of the insulating matrix is 20% or more.

3. The strain gauge according to claim 2,
wherein a degree of crystallinity of the insulating matrix is included in a range of 24% to 64%.

4. The strain gauge according to claim 3,
wherein L is one or more magnetic metal elements selected from Fe, Co, and Ni,
the degree of crystallinity of the insulating matrix is included in a range of 38% to 64%, and
a+b+c is included in a range of 50.1% to 59.1%.

5. The strain gauge according to claim 3,
wherein L is one or more nonmagnetic metal elements selected from Pt, Au, Ag, and Cu,
the degree of crystallinity of the insulating matrix is included in a range of 41% to 61%, and
a+b+c is included in a range of 54.5% to 58.1%.

6. The strain gauge according to claim 1,
wherein a change in a gauge rate within a temperature range of 0 to 50° C. is ±1500 ppm/° C. or less.

7. A strain measurement device comprising:
the strain gauge according to claim 1;
a circuit component constituting a bridge circuit including the strain gauge; and
a magnet configured to apply a magnetic field to the strain gauge.

8. A strain measurement method comprising:
a step of attaching the strain gauge according to claim 1 to an object;
a step of applying a magnetic field to the strain gauge using a magnet; and
a step of detecting strain appearance of the object according to a change in electrical resistance of the strain gauge.
